(19) United States
(12) Patent Application Publication
(10) Pub. No.: US 2026/0183946 A1
(43) Pub. Date: Jul. 2, 2026

(54) ROBOT APPARATUS, MULTI-ROBOT SYSTEM COMPRISING THE SAME, AND METHOD FOR ASSIGNING TASKS BETWEEN ROBOTS IN THE MULTI-ROBOT SYSTEM

(71) Applicant: KOREA INSTITUTE OF SCIENCE AND TECHNOLOGY, Seoul (KR)

(72) Inventors: Yoonseob LIM, Seoul (KR); Donggil LEE, Seoul (KR); Goeun LEE, Seoul (KR)

(21) Appl. No.: 19/425,759

(22) Filed: Dec. 18, 2025

(30) Foreign Application Priority Data
Dec. 30, 2024 (KR) 10-2024-0200069

(51) Int. Cl. B25J 9/16; B25J 9/00

(52) U.S. Cl. CPC B25J 9/1661; B25J 9/0084

(57) ABSTRACT

A multi-robot system configured to perform task allocation through a network among robots includes a plurality of robots executing a distributed algorithm designed to allocate tasks based on local data. The distributed algorithm transforms a task-allocation problem into a dual-form structure to be individually processed by each robot, and each robot is addable to or removable from the network without centralized information or an initialization procedure.

### CROSS-REFERENCE TO RELATED APPLICATION

This application claims priority under 35 U.S.C. § 119 to Korean Patent Application No. 10-2024-0200069 filed on Dec. 30, 2024, in the Korean Intellectual Property Office, the disclosures of which are incorporated by reference herein in their entireties.

### BACKGROUND

The present disclosure relates to a robot apparatus, a multi-robot system comprising the robot apparatus, and a method for assigning tasks between robots in the multi-robot system.

Recent advancements in network communication technologies have accelerated research on distributed task-assignment problems in multi-robot systems. Such research aims to determine an optimal task assignment in which a plurality of robots cooperate within a local framework, adopting task-assignment schemes based on information sharing among neighboring robots.

Conventional approaches focus on formulating the task-assignment problem in the form of mathematical programming and assigning tasks to individual robots. However, many existing studies consider a fixed number of robots (m), while limited research has addressed scenarios in which only a subset of robots is assigned from a larger robot pool (N>m). In such scenarios, robots that are not assigned to a task can be utilized to maintain continuity in the task flow or to replace robots that experience failures. Nevertheless, conventional approaches require additional solutions, such as initialization procedures or reliance on global information, when new robots are added or existing robots are removed, and thus have practical limitations.

### SUMMARY

According to embodiments of the present disclosure, a robot apparatus, a multi-robot system comprising the robot apparatus, and a method for assigning tasks between robots in the multi-robot system are provided.

According to an embodiment of the present disclosure, a multi-robot system that performs task assignment through an inter-robot network includes robots that execute a distributed algorithm designed to assign tasks based on local data. The distributed algorithm transforms a task-assignment problem into a dual-form structure that is individually processed by each robot, and each robot is added to or removed from the network without relying on centralized information or an initialization procedure.

According to an embodiment of the present disclosure, a robot apparatus for task assignment in a multi-robot system connected through a network includes a distributed algorithm configured to select an optimal task based on local data, processes a task-assignment problem transformed into a dual form in a local environment, and is added to or removed from the network without initialization.

According to an embodiment of the present disclosure, a method for assigning tasks between robots in a multi-robot system connected through a network includes collecting, by each robot, local data from neighboring robots; selecting, by each robot, an optimal task to be assigned based on the collected data; and locally processing a task-assignment problem transformed into a dual form based on the selected task, wherein the robots are integrated into or removed from the system without a separate initialization or centralized configuration when a robot is added or removed.

### BRIEF DESCRIPTION OF THE FIGURES

The above and other objects and features of the present disclosure will become apparent by describing in detail embodiments thereof with reference to the accompanying drawings.

FIG. 1 illustrates a multi-robot system according to an embodiment of the present disclosure.

FIGS. 2 and 3 are diagrams for describing tasks performed by robots according to an embodiment of the present disclosure.

FIGS. 4, 5, 6, 7, and 8 illustrate simulation results of tasks performed by robots according to an embodiment of the present disclosure.

FIG. 9 is a block diagram illustrating an apparatus according to an embodiment of the present disclosure.

### DETAILED DESCRIPTION

Hereinafter, embodiments of the present disclosure will be described clearly and in detail so that those of ordinary skill in the art may readily implement the invention.

Hereinafter, embodiments of the present disclosure will be described clearly and in detail so that those skilled in the art to which the present disclosure pertains can easily implement the present disclosure.

The terms “unit,” “module,” and the like used herein, and the functional blocks illustrated in the drawings, may be implemented in the form of software, hardware, or a combination thereof. In the following description, detailed descriptions of components that are duplicated will be omitted for clarity of the technical idea of the present invention.

In this document, phrases such as “A or B,” “at least one of A and B,” “at least one of A or B,” “A, B, or C,” “at least one of A, B, and C,” and “at least one of A, B, or C” may each include any one of the listed items or any possible combination thereof.

Embodiments of the present disclosure may provide a distributed architecture in which each robot assigns tasks using only local data without global information, and an algorithm having a plug-and-play capability that enables addition or removal of robots without an initialization procedure, thereby addressing the problems of the related art. Accordingly, flexibility and continuity of task flow can be maintained even when the composition of the robot team changes, and system scalability and stability can be ensured simultaneously. Hereinafter, detailed descriptions of embodiments of the present disclosure will be provided together with the drawings.

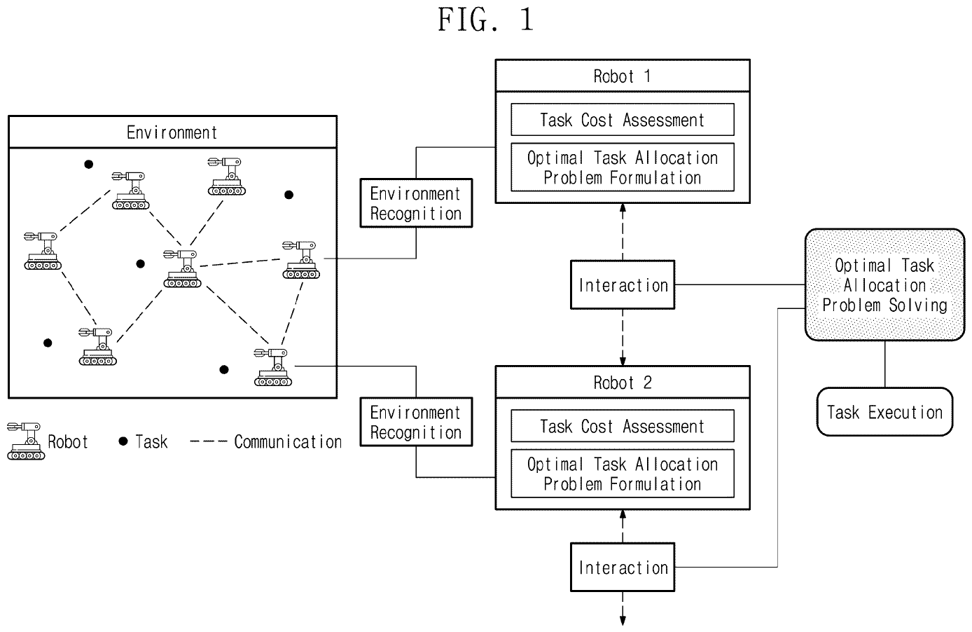

FIG. 1 illustrates a multi-robot system according to an embodiment of the present disclosure. The multi-robot system may include a plurality of robots, and tasks of the robots may be performed within an environment composed thereof.

A multi-robot system that performs task assignment through an inter-robot network may include robots that execute a distributed algorithm designed to assign tasks based on local data. The distributed algorithm may be executed by a processor included in each robot, and the processor may load code stored in a memory and/or storage for execution of the distributed algorithm.

In one example, the distributed algorithm transforms a task-assignment problem into a dual-form structure, which is individually processed by each robot, and each robot may be added to or removed from the inter-robot network without centralized information or an initialization procedure.

In one example, each robot collects local data through communication with neighboring robots, and the distributed algorithm may assign a task that minimizes a cost based on the collected local data. The distributed algorithm may also convert a task-assignment problem transformed into a dual form into an unconstrained optimization problem, and each robot may independently select an optimal task according to a cost function assigned thereto. For example, the distributed algorithm may dynamically reassign tasks among robots.

In one example, when a robot performing a task within a team enters a non-operational state, a robot that has been in a standby state may take over the task. For example, the distributed algorithm may adjust communication paths between robots according to the connection state of the inter-robot network, and may ensure continuity of task assignment even when the position of a robot changes or a new robot is added.

In one example, the multi-robot system may not require reconfiguration or initialization of the network even when robots are added, removed, or replaced. The distributed algorithm may designate a leader robot and may be configured such that when a robot is added to or removed from the team, the leader robot succeeds the role of the removed robot.

In one example, the inter-robot network is implemented using wireless communication, and the distributed algorithm may be configured to make individual task-assignment decisions based on information received from neighboring robots.

In one example, the distributed algorithm may be configured such that when a robot performing a task fails, a standby robot takes over the assigned task and continues performing it.

The optimal task-assignment problem according to an embodiment of the present disclosure may be defined based on Equation 1 below, and the distributed algorithm of the present disclosure may be based on the equations.

$$minimize {\sum }_{i ∈ 𝒩} {\sum }_{k ∈ ℳ} {c}_{i}^{k} ( {x}_{i}^{k} ) \qquad [ Equation 1 ]$$

$$subject to {\sum }_{k ∈ ℳ} {x}_{i}^{k} = 1 , ∀ i ∈ 𝒩$$

$${\sum }_{i ∈ 𝒩} {x}_{i}^{k} = 1 , ∀ k ∈ ℳ ∖ \{ 0 \}$$

$${x}_{i}^{k} ∈ [ 0 , 1 ] , ∀ i ∈ 𝒩 , k ∈ ℳ$$

Here, [symbol] ={1, . . . , N} denotes an index set of robots, and [symbol] ={0, . . . , m} may denote an index set of tasks. For determining task costs, a decision variable for task k of robot i is declared through

$${x}_{i}^{k} ∈ [ 0 , 1 ] ,$$

∀i∈ [symbol] , k∈ [symbol] , and a cost function for task k of robot i may be determined from

$${c}_{i}^{k} ( {x}_{i}^{k} ) .$$

An index set of neighboring robots of robot i is represented as [symbol] :={j|robot j can communicate with robot i}, and \hat{λ}ᵢ(t), \hat{μ}ᵢ(t), \hat{ν}ᵢ(t) may represent an estimated Lagrange variable of robot i in the present disclosure.

In the present disclosure, the dual function of robot i, denoted as gᵢ(λ^{k},νᵢ) is obtained by minimizing the Lagrangian of the optimization problem in Equation 1 with respect to the primal variables. Owing to the separable structure of the Lagrangian across robots and tasks, the minimization can be decomposed into independently solvable subproblems for the idle-task variable and the task variables. As a result, gᵢ(λ^{k},νᵢ) takes the form of Equation 2.

$${g}_{i} ( λ , {v}_{i} ) = {g}_{i}^{0} ( {v}_{i} ) + {\sum }_{k ∈ ℳ \backslash \{ 0 \}} {g}_{i}^{k} ( {λ}^{k} , {v}_{i} ) \qquad [ Equation 2 ]$$

$${g}_{i}^{0} ( {v}_{i} ) = {inf}_{{x}_{i}^{0} ∈ {𝒳}_{i}^{0}} [ {c}_{i}^{0} ( {x}_{i}^{0} ) + {v}_{i} ( 1 - {x}_{i}^{0} ) ]$$

$${g}_{i}^{k} ( {λ}^{k} , {v}_{i} ) = {inf}_{{x}_{i}^{k} ∈ {𝒳}_{i}^{k}} [ {c}_{i}^{k} ( {x}_{i}^{k} ) - {v}_{i} {x}_{i}^{k} + {λ}^{k} ( {δ}_{1 i} - {x}_{i}^{k} ) ]$$

Here, δ₁ᵢ denotes the Kronecker delta whose value is 1 when i=1 and 0 otherwise. This decomposition shows that each robot can compute its contribution to the dual problem using only local information, enabling distributed execution of the task-assignment algorithm.

Furthermore, the task-decision-variable transformation function of robot i, denoted as

$${θ}_{i}^{k} ( {λ}^{k} , {v}_{i} )$$

represents the optimal value of the primal variable x

$${x}_{i}^{k}$$

that minimizes the corresponding dual-transformed Lagrangian term. Because the local cost function

$${c}_{i}^{k} ( {x}_{i}^{k} )$$

is strictly convex and continuously differentiable, the minimizer is determined by comparing the combined gradient term (νᵢ+λ^{k}) with the gradient of the cost function evaluated at the endpoints of the feasible interval. Thus, the explicit expression of the transformation function is Equation 3.

$${θ}_{i}^{k} ( {λ}^{k} , {v}_{i} ) = \{ \begin{matrix}0 , & if {v}_{i} + {λ}^{k} < \frac{\partial {c}_{i}^{k}}{\partial {x}_{i}^{k}} ( 0 ) \\ {φ}_{i}^{k} ( {v}_{i} + {λ}^{k} ) , & if \frac{\partial {c}_{i}^{k}}{\partial {x}_{i}^{k}} ( 0 ) \leq {v}_{i} + {λ}^{k} \leq \frac{\partial {c}_{i}^{k}}{\partial {x}_{i}^{k}} ( 1 ) \\ 1 , & if \frac{\partial {c}_{i}^{k}}{\partial {x}_{i}^{k}} ( 1 ) < {v}_{i} + {λ}^{k}\end{matrix} \qquad [ Equation 3 ]$$

$$( {φ}_{i}^{k} ( \cdot ) denotes the inverse function of the derivative \frac{\partial {c}_{i}^{k}}{\partial {x}_{i}^{k}} ( {x}_{i}^{k} ) )$$

Based on the above, in order to solve the optimal task-assignment problem, a distributed algorithm based on Equation 4 below may be executed for each robot i.

$${\dot{\hat{λ}}}_{i} = \frac{\partial {g}_{i}}{\partial λ} ( {\hat{λ}}_{i} , {\hat{v}}_{i} ) + {\sum }_{j ∈ {𝒩}_{i}} ( {\hat{λ}}_{j} - {\hat{λ}}_{i} ) + {\sum }_{j ∈ {𝒩}_{i}} ( {\hat{μ}}_{j} - {\hat{μ}}_{i} ) \qquad [ Equation 4 ]$$

$${\dot{\hat{μ}}}_{i} = - {\sum }_{j ∈ {𝒩}_{i}} ( {\hat{λ}}_{j} - {\hat{λ}}_{i} )$$

$${\dot{\hat{v}}}_{i} = \frac{\partial {g}_{i}}{\partial {v}_{i}} ( {\hat{λ}}_{i} , {\hat{v}}_{i} )$$

From this, an optimal solution of

$${\hat{x}}_{i}^{k} ( {\hat{λ}}_{i} ( t ) , {\hat{v}}_{i} ( t ) ) = {θ}_{i}^{k} ( {\hat{λ}}_{i} ( t ) , {\hat{v}}_{i} ( t ) )$$

may be estimated based on the distributed algorithm.

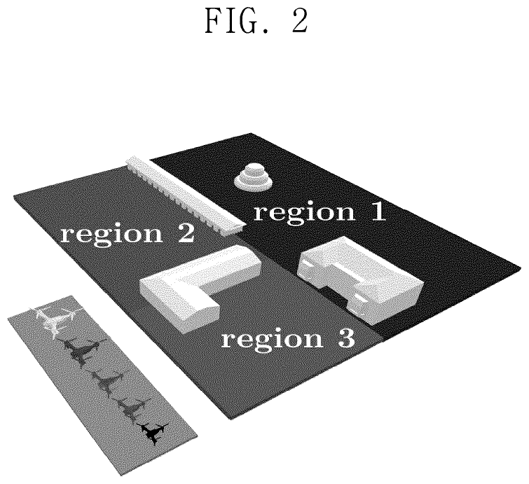

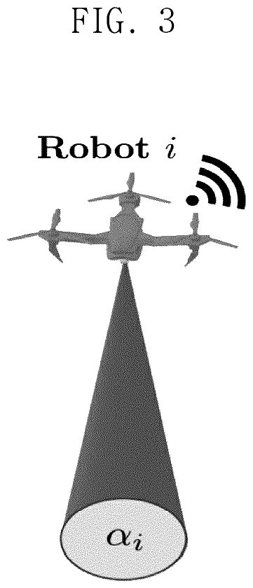

FIGS. 2 and 3 are diagrams for describing tasks performed by robots according to an embodiment of the present disclosure. Specifically, FIG. 2 illustrates five robots and three areas that are subject to patrol missions performed by the robots. A distributed task-assignment problem of a multi-robot surveillance system will be described with reference to FIG. 2. According to an embodiment of the present disclosure, in order to perform surveillance tasks at the lowest cost, one robot may be assigned to each surveillance area.

For example, when one robot is assigned to one area, the assigned robot may continuously patrol the designated area. As shown in FIG. 2, when a team consisting of N=5 robots is assigned to m=3 surveillance areas, a cost function for assigning robot i∈ [symbol] to surveillance area k∈ [symbol] \{0} may be defined as Equation 5 below.

$${c}_{i}^{k} ( {x}_{i}^{k} ) = \frac{{β}_{k}}{{α}_{i}} [ {x}_{i}^{k} + ρ \cdot {( {x}_{i}^{k} )}^{2} ] \qquad [ Equation 5 ]$$

When robot i is in an idle state (i.e., no surveillance task is assigned), a cost function of robot i may be defined as Equation 6 below.

$${c}_{i}^{0} ( {x}_{i}^{0} ) = {γ}_{i} [ {x}_{i}^{0} + ρ \cdot {( {x}_{i}^{0} )}^{2} ] \qquad [ Equation 6 ]$$

In Equations 5 and Equation 6, αᵢ denotes an area that robot i can patrol at each moment, and αᵢ may denote an area size of surveillance region k. Exemplary values of αᵢ, βₖ, and γᵢ are disclosed in Table 1 and Table 2. A constant ρ=0.01 is included to ensure strict convexity

$${c}_{i}^{k}$$

of the cost function.

TABLE 1

| | Robot 1 | Robot 2 | Robot 3 | Robot 4 | Robot 5 |
|---|---|---|---|---|---|
| αᵢ | 1 | 2 | 3 | 4 | 5 |
| γᵢ | 0.1 | 0.1 | 0.1 | 0.1 | 0.1 |

TABLE 2

| | Robot 1 | Robot 2 | Robot 3 |
|---|---|---|---|
| βₖ | 30 | 20 | 10 |

In the simulation according to an embodiment of the present disclosure, a scenario in which a robot can be integrated into or removed from a team to demonstrate the plug-and-play capability may be presented as follows:
Initially, five robots denoted as i∈ [symbol] ={1, 2, 3, 4, 5} are deployed.
At t=200 seconds, two robots denoted as i∈{4, 5} leave the team due to battery depletion.
The robot denoted as i=4 recharges its battery and rejoins the team at t=400 seconds to support the surveillance task.

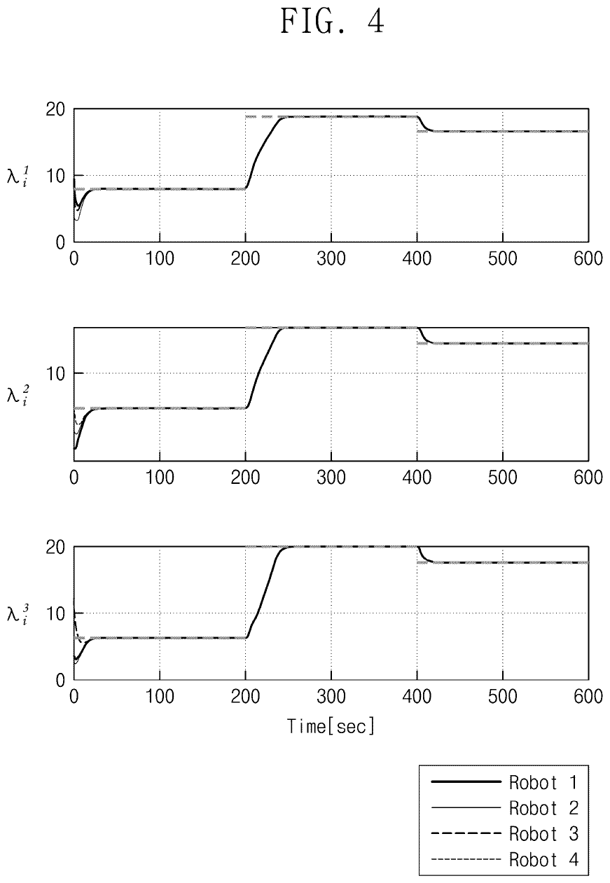

FIGS. 4 through 8 illustrate simulation results of tasks performed by robots according to an embodiment of the present disclosure.

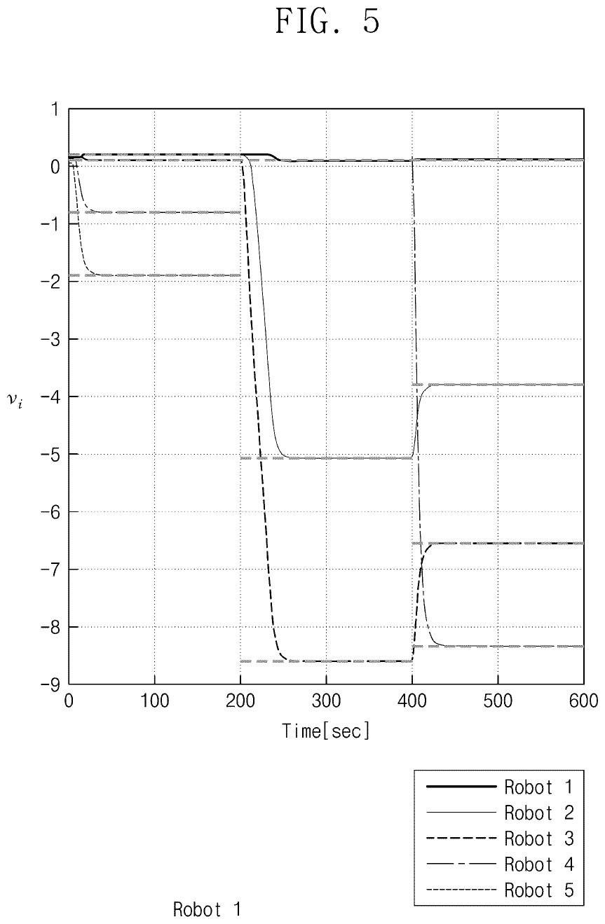

In FIGS. 4 and 5, graphs for two estimated variables

$${\hat{λ}}_{i}^{k} ( t )$$

and \hat{ν}ᵢ(t) based on Equation 4 are shown. All estimated values converge to optimal values as time elapses, which may be valid for each time interval.

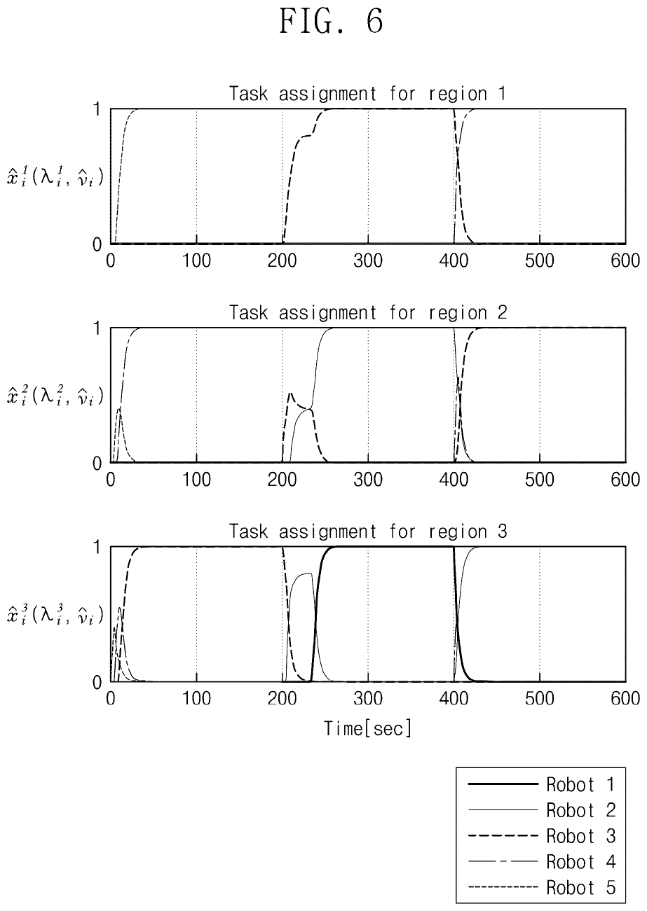

Meanwhile, FIGS. 6 through 8 illustrate task results related to the estimates

$${\hat{λ}}_{i}^{k} ( t )$$

and \hat{ν}ᵢ(t). Specifically, FIG. 6 presents an estimated variable

$${\hat{x}}_{i}^{k} ( {\hat{λ}}_{i}^{k} ( t ) , {\hat{v}}_{i} ( t ) )$$

for optimal

$${x}_{i}^{k *} .$$

The estimated values are displayed sequentially from top to bottom for k=1, 2, and 3. During the time interval t∈[0,200), referring first to the estimate

$${\hat{x}}_{i}^{k} ( {\hat{λ}}_{i}^{k} ( t ) , {\hat{v}}_{i} ( t ) )$$

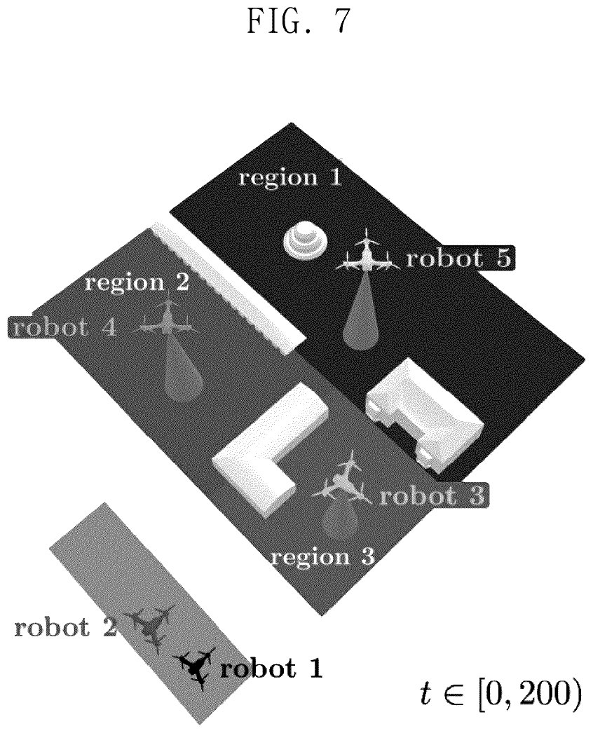

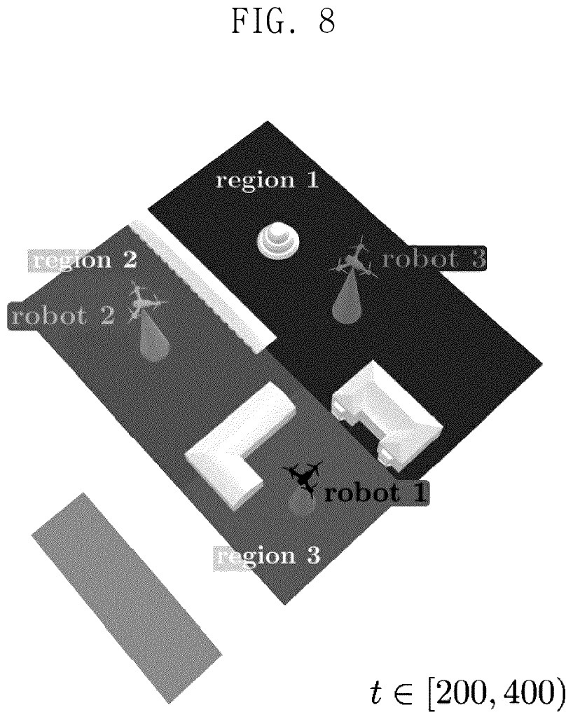

for Region 1 shown in the top panel of FIG. 6, the estimate converges to 1 when i=5, as indicated by the yellow dashed line, whereas it approaches 0 when i=1, 2, 3, and 4. As a result, region 1 is assigned to robot 5. Following this procedure, one can infer that regions 2 and 3 are assigned to robots 4 and 3, respectively. During the interval t∈[200, 400), when robots 4 and 5 are absent from the team, robots 3, 2, and 1 may perform surveillance tasks for regions 1, 2, and 3. In the final interval t∈[400, 600), robot 4 rejoins the team, and regions 1, 2, and 3 may be reassigned to robots 4, 3, and 2, respectively. FIGS. 7 and 8 illustrate the configuration of all assignment states during the intervals t∈[0, 200) and t E [200, 400).

According to the embodiments described above, a distributed algorithm for solving a task-assignment problem of networked robots with the objective of minimizing total cost may be provided. The approach of the present disclosure transforms an original optimization problem into an unconstrained dual form and solves it using a distributed solver tailored to distributed optimization problems. The proposed algorithm has two main characteristics: First, the distributed architecture allows each robot to assign tasks using only local data, eliminating dependency on global information. Second, since initialization is not required, complex initial setup procedures are unnecessary. These advantages ensure adaptability by enabling flexible task reassignment when the composition of the robot team changes, thereby maintaining efficient task operations.

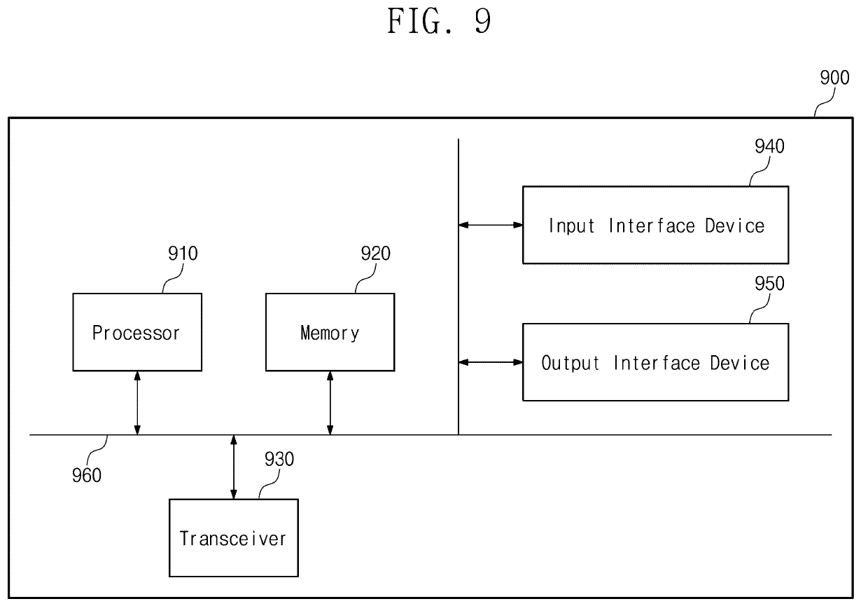

FIG. 9 is a block diagram illustrating an apparatus according to an embodiment of the present disclosure. The apparatus in FIG. 9 may represent each robot in FIG. 1.

For example, apparatus 900 may support and perform functions such as storing and processing local data, communicating with neighboring robots, executing the distributed algorithm to determine task assignments, and exchanging information for dynamic task reassignment within the robot network.

Apparatus 900 may include at least one of a processor 910, a memory 920, a transceiver 930, an input interface device 940, and an output interface device 950. The respective components may communicate with one another through a common bus 960. Alternatively, the respective components may be connected via individual interfaces or individual buses centered around processor 910 rather than the common bus 960.

Processor 910 may be implemented in various forms such as an application processor (AP), a central processing unit (CPU), or a graphic processing unit (GPU), and may be any semiconductor device that executes instructions stored in memory 920. Processor 910 may execute program commands stored in memory 920. Processor 910 may be configured to perform the algorithms described with reference to FIGS. 1 through 8.

And/or, processor 910 may store in memory 920 at least one program command to implement at least one function of the modules, and may control execution of the operations described with reference to FIGS. 1 through 8.

Memory 920 may include various types of volatile or non-volatile storage media. For example, memory 920 may include a read-only memory (ROM) and a random-access memory (RAM). In an embodiment of the present disclosure, memory 920 may be located inside or outside processor 910 and may be connected to processor 910 through various known means.

Transceiver 930 may perform a function of transmitting and receiving data to and from an external device and/or external system for data processed or to be processed by processor 910.

Input interface device 940 is configured to provide data to processor 910.

Output interface device 950 is configured to output data from processor 910.

At least a portion of the distributed task-allocation method according to an embodiment of the present disclosure may be implemented as a program or software executed by a computing device, and the program or software may be stored in a computer-readable medium.

Alternatively, at least a portion of the distributed task-allocation method may be implemented in hardware that is electrically connected to or incorporated within a computing device.

Embodiments of the present disclosure can maximize efficiency and flexibility in task assignment within a network-based robot system. Through a plug-and-play capability, a newly added robot is immediately integrated into the network without an initialization process, and the continuity and efficiency of tasks can be maintained through optimized task assignment based on a cost function. Additionally, by employing a distributed architecture, tasks are processed solely through local data and communication among neighboring robots, without relying on centralized information or global data, thereby significantly enhancing the scalability and stability of the system.

According to embodiments of the present disclosure, when a robot fails or the team configuration changes, a standby robot can automatically take over the task, preventing interruption of the task flow. The embodiments of the present disclosure are applicable to various dynamic environments and can ensure efficient operation and reliability of multi-robot systems, particularly in work environments such as logistics, surveillance, and manufacturing.

The foregoing description illustrates specific embodiments for implementing the present invention. However, the present invention is not limited to the embodiments described above, and various modifications or alternative embodiments that may be readily made by those skilled in the art based on the basic concepts of the present disclosure are also within the scope of the present invention. Further, the present invention includes technologies that may be easily modified or implemented based on the embodiments. Therefore, the scope of the present invention should not be limited to the embodiments described above, but should be defined by the claims described below and their equivalents.

The embodiments of the present disclosure may be implemented not only through the apparatus and/or method described above, but also through a program or a recording medium storing such a program that realizes functions corresponding to components of the embodiments. Such implementation can be readily achieved by those skilled in the art based on the description of the embodiments above.

Although embodiments of the present disclosure have been described in detail above, the scope of the present disclosure is not limited thereto, and various modifications and improvements made by those skilled in the art using the basic concepts of the present disclosure also fall within the scope of the present disclosure.

What is claimed is:

1. A multi-robot system configured to perform task allocation through a network among robots, the system comprising:
a plurality of robots each executing a distributed algorithm designed to allocate tasks based on local data,
wherein the distributed algorithm transforms a task-allocation problem into a dual-form structure to be individually processed by each of the robots, and
wherein each of the robots is addable to or removable from the network of robots without centralized information or an initialization process.

2. The multi-robot system of claim 1,
wherein each of the robots collects local data through communication with adjacent robots, and
wherein the distributed algorithm allocates tasks that minimize cost based on the collected local data.

3. The multi-robot system of claim 1,
wherein the distributed algorithm converts the dual-form task-allocation problem of the robots into an unconstrained optimization problem, and
wherein each of the robots independently selects an optimal task according to a cost function assigned thereto.

4. The multi-robot system of claim 1,
wherein the distributed algorithm performs dynamic reallocation of tasks among the robots.

5. The multi-robot system of claim 1,
wherein, when a robot performing a task enters an inactive state, a standby robot is configured to take over the task.

6. The multi-robot system of claim 1,
wherein the distributed algorithm adjusts communication paths among the robots according to a connection state of the network of robots, and
wherein continuity of task allocation is ensured even when a position of a robot changes or a new robot is added.

7. The multi-robot system of claim 1,
wherein the multi-robot system does not require reconfiguration or initialization of the network when a robot is added, removed, or replaced.

8. The multi-robot system of claim 7,
wherein the distributed algorithm designates a leader robot, and
wherein the leader robot succeeds a role of a removed robot when the robot is added to or removed from a team.

9. The multi-robot system of claim 1,
wherein the network among the robots is implemented through wireless communication, and
wherein the distributed algorithm is configured to make individual task-allocation decisions based on information received from adjacent robots.

10. The multi-robot system of claim 1,
wherein, when a robot performing a task fails, a standby robot takes over the allocated task and continuously performs the task.

11. A robot apparatus for task allocation in a multi-robot system connected through a network, the apparatus comprising:
a distributed algorithm configured to select an optimal task based on local data,
wherein a task-allocation problem converted into a dual form is processed in a local environment, and
wherein the apparatus is addable to or removable from the network without initialization.

12. A method of allocating tasks among robots in a multi-robot system connected through a network, the method comprising:
collecting, by each robot, local data from adjacent robots;
selecting, by each robot, an optimal task to be allocated thereto based on the collected data; and
processing, by each robot, a task-allocation problem converted into a dual form in a local environment,
wherein the robots are integrated into or separated from the network without separate initialization or centralized configuration when a robot is added or removed.
